(19) United States
(12) Patent Application Publication
(10) Pub. No.: US 2015/0054270 A1
(43) Pub. Date: Feb. 26, 2015

(54) METHOD OF FORMING CRASH PAD AND CRASH PAD FORMED THEREBY

(71) Applicant: HYUNDAI MOBIS CO., LTD., YONGIN-SI (KR)

(72) Inventor: Byung Young KANG, Yongin-si (KR)

(21) Appl. No.: 14/458,332

(22) Filed: Aug. 13, 2014

(30) Foreign Application Priority Data
Aug. 23, 2013 (KR) 10-2013-0100608

(51) Int. Cl. B60R 21/045; B29C 41/18; B29C 51/10; B29C 44/12

(52) U.S. Cl. CPC B60R 21/045; B29C 44/12; B29C 41/18; B29C 51/10; B29K 2075/00
USPC 280/752; 264/46.5

(57) ABSTRACT

According to a method of forming a crash pad and a crash pad formed thereby according to the present invention, skin is formed to be minimized in size so as to have a shape similar to a final shape, thereby minimizing portions of the skin which are discarded, and reducing manufacturing costs.

### CROSS-REFERENCE TO RELATED APPLICATIONS

The present application claims priority to Korean Patent Application Number 10-2013-0100608 filed Aug. 23, 2013, the entire contents of which the application is incorporated herein for all purposes by this reference.

### TECHNICAL FIELD The present invention relates to a method of forming a crash pad and a crash pad formed thereby.

### BACKGROUND In general, various types of convenient devices and safety structures for making a comfortable, pleasant and practical interior environment are mounted in a vehicle.

Here, switches for controlling various types of indicators, an air conditioner, and an audio system are mounted in front of a driver seat. Further, in addition to the aforementioned devices, a crash pad is provided so as to safely protect an occupant from a collision at the time of a collision of the occupant due to an accident.

An upper portion of the crash pad is formed to be elongated leftward and rightward such that both ends thereof are coupled to left and right side members of a vehicle, respectively, and a middle portion of the crash pad, which is commonly called a center fascia, is extended downward to be elongated upward and downward, and coupled to a front floor, which is a bottom surface of an occupant compartment.

The crash pad is classified into a soft type crash pad and a hard type crash pad. The soft type crash pad has three layers (skin, foam, and core) at a cross section thereof so as to provide a soft external appearance, soft tactile property, and soft cushioning property. The hard type crash pad has a single layer (core), and is a product manufactured by injection molding using plastic.

Recently, the soft type crash pad, which is formed by foaming and autonomously provides cushioning property, is mainly used, thereby providing user friendly tactile property to a driver and a passenger.

Here, skin formed on a surface of the crash pad may make the occupant compartment of the vehicle luxurious, but there is a problem in that a material of the skin is costly.

In particular, when the crash pad in the related art is manufactured, the skin is formed to have a large area, a foam layer is formed between the skin and a core, and a portion, which is irrelevant to a final shape, is cut and discarded after foaming.

Here, in the related art, there is a problem in that manufacturing cost of the crash pad is high because a large area of the skin is cut and discarded.

Meanwhile, in a case in which the skin is manufactured to have an area similar to an area of the final shape, a foaming material is attached to a mold during a foaming process which causes a defect, and the foaming material invades the surface of the skin which causes a defect, and as a result, there is a problem in that the skin in the related art needs to be manufactured to cover a large area so that the foaming material cannot be in contact with the mold.

### SUMMARY

The present invention has been made in an effort to provide a method of forming a crash pad and a crash pad formed thereby which may minimize wastefulness of a material, and form a soft surface.

An exemplary embodiment of the present invention provides a method of forming a crash pad, including: a step S10 of manufacturing skin that forms a surface of the crash pad; a step S20 of attaching a film to a surface of the skin so as to form film skin; a step S30 of manufacturing a core separately from the skin; a step S40 of disposing the film skin and the core in a mold so as to be spaced apart from each other at a predetermined interval; a step S50 of forming a foam layer between the film skin and the core so as to manufacture a primary crash pad; a step S60 of cutting the primary crash pad so as to manufacture a secondary crash pad; and a step S70 of removing the film 20 attached to a surface of the secondary crash pad.

Another exemplary embodiment of the present invention provides a method of forming a crash pad, including: a step S10 of manufacturing skin that forms a surface of the crash pad; a step S20 of attaching a film to a surface of the skin so as to form film skin; a step S30 of manufacturing a core separately from the skin; a step S40 of disposing the film skin and the core in a mold so as to be spaced apart from each other at a predetermined interval; a step of forming a foam layer between the film skin and the core so as to manufacture an intermediate crash pad; and a step S70 of removing the film 20 attached to a surface of the intermediate crash pad.

Yet another exemplary embodiment of the present invention provides a method of forming a crash pad, including: a step S10 of manufacturing skin that forms a surface of the crash pad; a step S20 of disposing a film on a surface of the skin, and forming film skin to which the skin and the film are attached by a vacuum forming method; a step S30 of manufacturing a core separately from the skin; a step S40 of disposing the film skin and the core in a mold so as to be spaced apart from each other at a predetermined interval; a step S50 of forming a foam layer between the film skin and the core so as to manufacture a primary crash pad; a step S60 of cutting the primary crash pad so as to manufacture a secondary crash pad; and a step S70 of removing the film 20 attached to a surface of the secondary crash pad.

In the step S10, the skin may be manufactured by a powder slush molding (PSM) method.

In the step S20, the film may be manufactured by a vacuum forming method.

In the step S10, the skin may be manufactured by a vacuum forming method.

The skin may be made of a thermoplastic olefin (TPO) material or a thermoplastic urethane (TPU) material.

According to the method of forming a crash pad and the crash pad formed thereby according to the present invention, the skin is formed to be minimized in size so as to have a shape similar to a final shape, thereby minimizing portions of the skin which are discarded, and reducing manufacturing costs.

### BRIEF DESCRIPTION OF THE DRAWINGS

FIG. 1 is a flowchart illustrating a method of forming a crash pad according to a first exemplary embodiment of the present invention.

FIG. 2 is a front view of the crash pad manufactured by the method of FIG. 1.

FIG. 3 is a front view of film skin manufactured by the method of FIG. 1.

FIG. 4 is a schematic cross-sectional view illustrating a process of manufacturing the crash pad according to the method of FIG. 1.

FIG. 5 is a schematic cross-sectional view illustrating a forming process of step S20 of FIG. 1.

### DETAILED DESCRIPTION

Hereinafter, the present invention will be specifically described with reference to the accompanying drawings.

However, in the description of the present invention, the specific descriptions of publicly known related functions or configurations thereof will be omitted when it is determined that the specific descriptions unnecessarily obscure the subject matter of the present invention. Parts will be indicated by different reference numerals when the parts are different although the terms of the parts are identical to each other.

Meanwhile, the terms used in the description are defined considering the functions of the present invention and may vary depending on the intention or usual practice of a user such as an experimenter and a measurer. Therefore, the definitions should be made based on the entire contents of the present specification.

In the present specification, the terms ‘first’, ‘second’ and the like may be used to describe various constituent elements, but the constituent elements should not be limited by the terms. The terms are used only for the purpose of distinguishing one constituent element from other constituent elements. For example, a first constituent element may be referred to as a second constituent element, and similarly, the second constituent element may also be referred to as the first constituent element, without departing from the scope of the present invention. The term ‘and/or’ includes a combination of a plurality of relevant disclosed items or any one item of the plurality of relevant disclosed items.

Terms used in the present specification are used only to describe specific exemplary embodiments, and are not intended to limit the present invention. Singular expressions used herein include plurals expressions unless they have definitely opposite meanings.

All terms used herein including technical or scientific terms have the same meanings as meanings which are generally understood by those skilled in the art unless they are differently defined. Terms defined in a generally used dictionary shall be construed that they have meanings matching those in the context of a related art, and shall not be construed in ideal or excessively formal meanings unless they are clearly defined in the present application.

In addition, unless explicitly described to the contrary, the word “comprise” and variations such as “comprises” or “comprising” will be understood to imply the inclusion of stated elements but not the exclusion of any other elements.

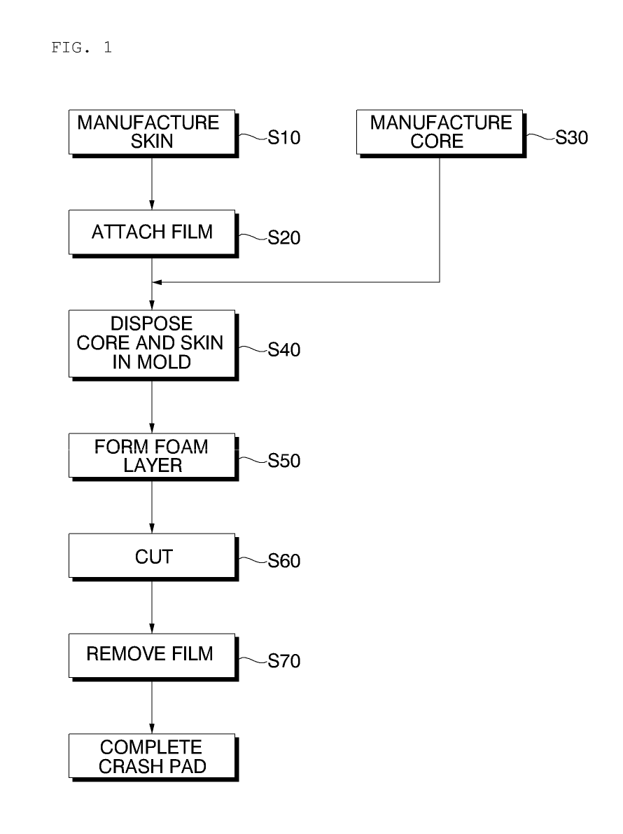

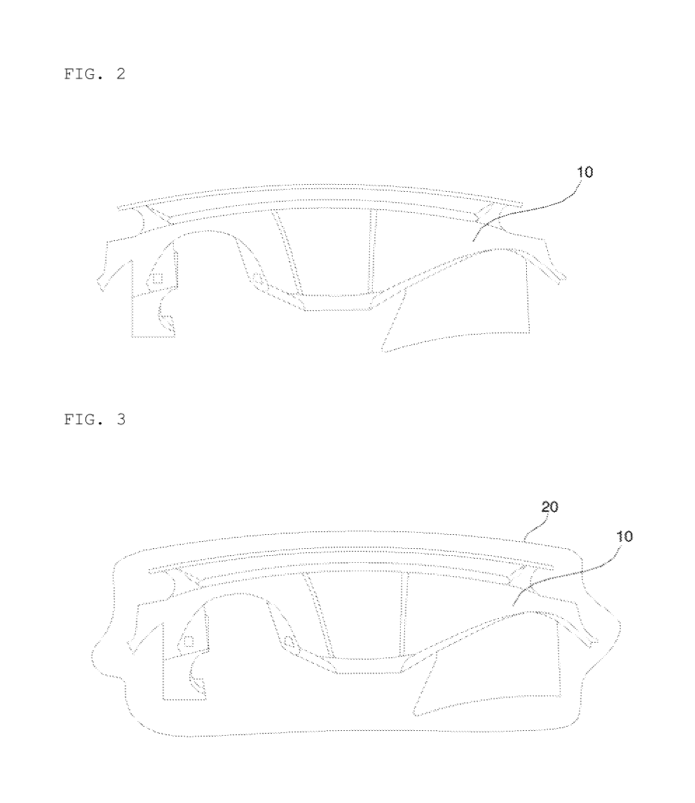

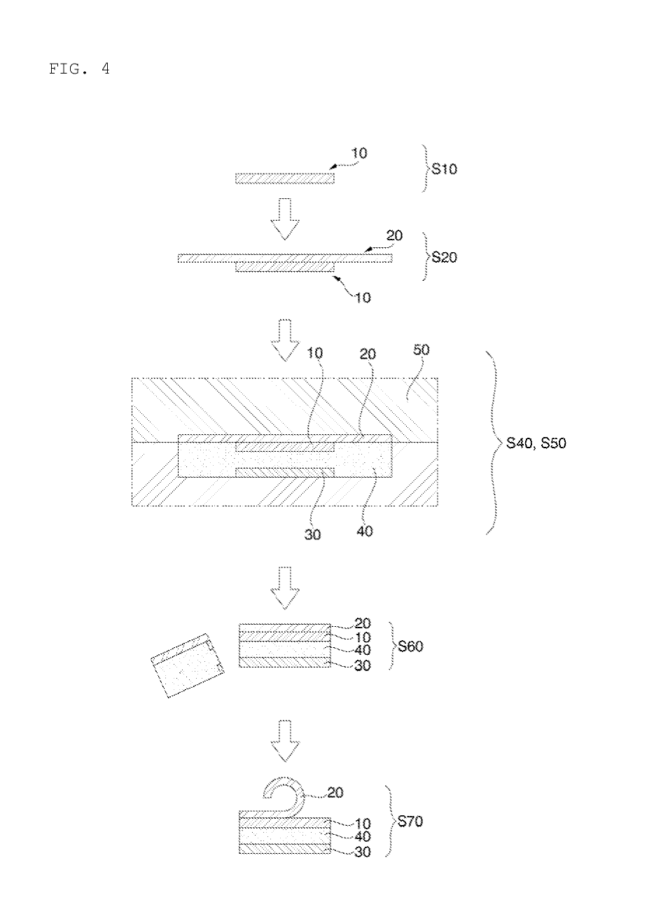

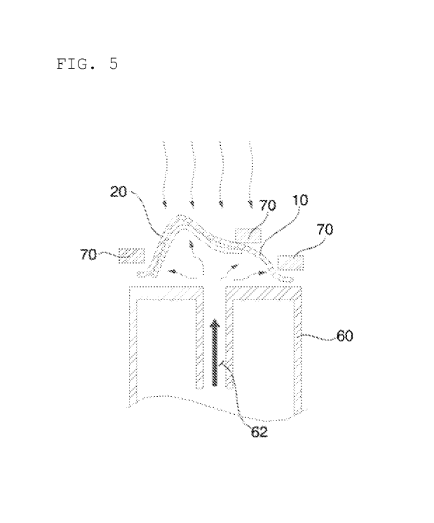

FIG. 1 is a flowchart illustrating a method of forming a crash pad according to a first exemplary embodiment of the present invention, FIG. 2 is a front view of the crash pad manufactured by the method of FIG. 1, FIG. 3 is a front view of film skin manufactured by the method of FIG. 1, FIG. 4 is a schematic cross-sectional view illustrating a process of manufacturing the crash pad according to the method of FIG. 1, and FIG. 5 is a schematic cross-sectional view illustrating a forming process of step S20 of FIG. 1.

Referring to the drawings, a method of forming a crash pad according to the present exemplary embodiment, a step S10 of manufacturing skin 10, which forms a surface of the crash pad, with a size of a finished product of the crash pad, a step S20 of attaching a film 20 on a surface of the skin 10 to form film skin, a step S30 of manufacturing a core 30 separately from the skin 10, a step S40 of disposing the film skin and the core in a mold 50 so as to be spaced apart from each other at a predetermined interval, a step S50 of forming a foam layer 40 between the film skin and the core 30 so as to manufacture a primary crash pad, a step S60 of cutting the primary crash pad so as to manufacture a secondary crash pad, and a step S70 of removing the film 20 attached to a surface of the secondary crash pad.

The primary crash pad and the secondary crash pad are intermediate crash pads, and in a case in which no margin for cutting is provided, the skin 10 in the step 10 and the final crash pad have the same area.

The skin 10 may form a surface of the crash pad 100, may provide soft tactile property to a user, and may be manufactured in a final shape of the crash pad 100, but the skin 10 may be formed to have a size larger by 5% or less than the final shape in consideration of processing tolerance.

Here, the skin 10 may be manufactured by a powder slush molding (PSM) method or a vacuum forming method, and may be made of a thermoplastic olefin (TPO) material or a thermoplastic urethane (TPU) material. The TPO material or the TPU material is more expensive than the film 20, but provides user friendly tactile property.

Among methods that may manufacture a skin layer of the crash pad, the PSM method is a method which has excellent design and embossing property, and forms the skin by rotating a heated mold and a material powder box. As a material that is generally used, polyvinyl chloride (PVC) powder was used in the related art, but as environmentally friend materials are developed, the recent trend is that the thermoplastic olefin (TPO) material and the thermoplastic urethane (TPU) material are widely used.

Among methods of manufacturing the skin of the crash pad, the vacuum forming method is a manufacturing method that is most common and has been used for a long time. A male type vacuum forming method is a method of heating a sheet having grain and color, attaching the sheet to the mold using vacuum, and cooling and forming the sheet. A female type vacuum forming method is a method in which the sheet has no grain, and the mold has grain, such that embossing property may be excellently provided to the skin when a preheated sheet is attached to the mold by vacuum and formed.

Because the PSM method and the vacuum forming method are general technologies known to those skilled in the art, a detailed description thereof will be omitted.

In particular, in the present exemplary embodiment, in order to minimize wastefulness of a material, the skin 10 is manufactured to have a size almost identical to a size of the final shape, thereby minimizing an area that is cut in the step S60.

The film 20 is formed of a vinyl material, and manufactured to have a wide area so as to cover an area of the mold 50 that is used in the step S50.

The film skin is an intermediate formed product in a state in which the film 20 is attached to the surface of the skin, and the film 20 is compressed and fixed to an upper surface of the skin 10.

Here, the film 20 is fixed to a curved portion of the skin 10 by a separate adhesive, thereby preventing the film 20 from floating.

The adhesive may be made of a material that causes no remnant on the surface of the skin 10 when the film 20 is removed.

The core 30 is a member that is disposed below the crash pad so as to maintain strength, and may be formed of polycarbonate (PC), acrylonitrile butadiene styrene (ABS) and the like.

The foam layer 40 is formed by foaming using urethane, and provides cushioning property to the crash pad.

In the step S10 and the step S30, the skin 10 and the core 30 are manufactured, respectively.

The film 20 is attached to the surface of the skin 10 manufactured in the step S20, and is widely manufactured so as to cover the film 20 and the mold 50.

In the step S40, the film skin and the core 30 are disposed in the mold 50, and in the present exemplary embodiment, the core 30 is disposed at a lower side of the mold 50, and the film skin is disposed at an upper side of the core 30.

Unlike the present exemplary embodiment, the core 30 may be disposed at the upper side, and the film skin may be disposed at the lower side.

In the step S50, urethane is formed between the film skin and the core 30 by foaming, thereby forming the foam layer 40.

The foam layer 40 is formed in the mold 50 by foaming, and a flow of the foam layer 40, which is formed by foaming, is restricted by the film 20, thereby preventing the foam layer 40 from flowing over toward the mold 50.

In particular, the skin 10 cannot restrict a flow of the foam layer 40 because the skin 10 is manufactured to have an area similar to an area of the final shape in order to prevent wastefulness of a material, but the foam layer 40 is formed by foaming at a normal position by the film 20 that is manufactured to have a wide area.

Moreover, in a case in which the foam layer 40 flows outward from the film 20, the mold may be damaged, and the surface of the skin 10 of the crash pad, which is produced, may be contaminated, which causes a defect.

The film 20 has an effect of suppressing the aforementioned defect.

Thereafter, in the step S60, the foam layer 40 formed outside the skin 10 is removed, and edges of the skin film and the core 30 are cut to have the final shape of the crash pad.

Further, in the step S70, the film 20 attached to the surface of the skin film is removed, and a process of manufacturing the crash pad is completed.

Here, the process of removing the film 20 may be performed in a line for manufacturing the crash pad, and may be performed in an assembly line before a vehicle is assembled.

As described above, according to the method of forming the crash pad according to the present exemplary embodiment, the skin 10 is manufactured while minimizing an area of the skin 10 which holds a major part of manufacturing costs, thereby reducing manufacturing costs of the crash pad.

In addition, according to the method of forming the crash pad according to the present exemplary embodiment, an area of the skin 10 is minimized, thereby minimizing a volume and a weight of the skin 10 during a manufacturing process.

Meanwhile, referring to FIG. 5, regarding the film skin, the skin 10 is mounted in the mold having an air hole, the film 20 is disposed at an upper side of the skin 10, and thereafter, the film 20 is attached to the skin 10 by supplying high-temperature air to the upper and lower sides of the skin 10.

Here, a clamp may be further disposed so as to more easily attach the film 20 when the film 20 is attached.

Moreover, when the film 20 is attached to a curved portion of the skin 10, an adhesive is applied onto a part thereof, and thereafter, the film 20 may be easily attached by compressing the film 20 using the clamp.

In particular, the adhesive may be applied onto a portion that is irrelevant to the final shape of the crash pad. That is, the adhesive may be applied onto only a portion that is cut in a subsequent process.

Meanwhile, in the present exemplary embodiment, the skin 10 is manufactured by the powder slush molding (PSM) method, and the method of attaching the film 20 to the skin 10 so as to manufacture the film skin is performed as the vacuum forming method.

In addition, although not illustrated, unlike the present exemplary embodiment, an original sheet of the skin and an original sheet of the film may be disposed together, and thereafter, the film skin may be manufactured by the vacuum forming method.

The exemplary embodiments of the present invention have been described above with reference to the accompanying drawings, but it can be understood that the present invention is not limited to the exemplary embodiments, but may be embodied in various different forms, and the present invention may be implemented in other specific forms by those skilled in the technical field to which the present invention pertains without changing the technical spirit or essential features of the present invention. Therefore, it should be understood that the aforementioned exemplary embodiments are described for illustration in all aspects and are not limited.

1. A method of forming a crash pad, comprising:
a step S10 of manufacturing skin that forms a surface of the crash pad;
a step S20 of attaching a film to a surface of the skin so as to form film skin;
a step S30 of manufacturing a core separately from the skin;
a step S40 of disposing the film skin and the core in a mold so as to be spaced apart from each other at a predetermined interval;
a step S50 of forming a foam layer between the film skin and the core so as to manufacture a primary crash pad;
a step S60 of cutting the primary crash pad so as to manufacture a secondary crash pad; and
a step S70 of removing the film attached to a surface of the secondary crash pad.

2. The method of claim 1, wherein in the step S10, the skin is manufactured by a powder slush molding (PSM) method.

3. The method of claim 2, wherein in the step S20, the film is manufactured by a vacuum forming method.

4. The method of claim 1, wherein in the step S10, the skin is manufactured by a vacuum forming method.

5. A method of forming a crash pad, comprising:
a step S10 of manufacturing skin that forms a surface of the crash pad;
a step S20 of attaching a film to a surface of the skin so as to form film skin;
a step S30 of manufacturing a core separately from the skin;
a step S40 of disposing the film skin and the core in a mold so as to be spaced apart from each other at a predetermined interval;
a step of forming a foam layer between the film skin and the core so as to manufacture an intermediate crash pad; and
a step S70 of removing the film attached to a surface of the intermediate crash pad.

6. The method of claim 5, wherein in the step S10, the skin is manufactured by a powder slush molding (PSM) method.

7. The method of claim 6, wherein in the step S20, the film is manufactured by a vacuum forming method.

8. The method of claim 5, wherein in the step S10, the skin is manufactured by a vacuum forming method.

9. A method of forming a crash pad, comprising:
a step S10 of manufacturing skin that forms a surface of the crash pad;
a step of disposing a film on a surface of the skin, and forming film skin to which the skin and the film are attached by a vacuum forming method;
a step S30 of manufacturing a core separately from the skin;
a step S40 of disposing the film skin and the core in a mold so as to be spaced apart from each other at a predetermined interval;
a step S50 of forming a foam layer between the film skin and the core so as to manufacture a primary crash pad;
a step S60 of cutting the primary crash pad so as to manufacture a secondary crash pad; and
a step S70 of removing the film attached to a surface of the secondary crash pad.

10. The method of claim 1, wherein the skin is made of a thermoplastic olefin (TPO) material or a thermoplastic urethane (TPU) material.

11. A crash pad manufactured by the method of claim 1.

12. The method of claim 5, wherein the skin is made of a thermoplastic olefin (TPO) material or a thermoplastic urethane (TPU) material.

13. The method of claim 9, wherein the skin is made of a thermoplastic olefin (TPO) material or a thermoplastic urethane (TPU) material.

14. A crash pad manufactured by the method of claim 5.

15. A crash pad manufactured by the method of claim 9.
